(19) United States
(12) Patent Application Publication
(10) Pub. No.: US 2026/0210418 A1
(43) Pub. Date: Jul. 23, 2026

(54) METHOD FOR PRODUCING A BRAKING ELEMENT, AND BRAKING ELEMENT

(71) Applicant: C4 Laser Technology GmbH, Freital (DE)

(72) Inventors: Tilo Steinmeier, Pohrsdorf (DE); Rene Bischoff, Dresden (DE)

(21) Appl. No.: 19/138,775

(22) PCT Filed: Dec. 14, 2023
(86) PCT No.: PCT/EP2023/085971

§ 371 Date: Jun. 13, 2025

(30) Foreign Application Priority Data
Dec. 20, 2022 (DE) 10 2022 134 171.2

(51) Int. Cl. F16D 65/12; F16D 65/02; F16D 65/10; F16D 69/00; F16D 69/02; F16D 69/04

(52) U.S. Cl. CPC F16D 65/127; F16D 65/10; F16D 65/125; F16D 69/027; F16D 69/04; F16D 65/128; F16D 2065/132; F16D 2069/005; F16D 2069/0483; F16D 2069/0491; F16D 2200/0013; F16D 2200/0021; F16D 2250/0007; F16D 2250/0038; F16D 2250/0046

(57) ABSTRACT

The invention relates to a method for producing a braking element and to a braking element. The object of the present invention is to provide a production method for a braking element which is cost-effective, saves material, and is simple. In addition, the object of the invention is to present a braking element that is weight-optimized and has improved wear and corrosion protection. The object is achieved by a method for producing a braking element which consists of a metal main body made of a cast material, having at least one disk-shaped or annular friction surface, wherein the cast metal main body has a base structure, a defective bainitic structure, and a cast skin layer which forms the cast surface, wherein for the metal part, the cast skin layer is at least partly removed at least in the region of the provided friction surface using a first machining process, a wear and/or corrosion protection layer is then arranged at least on the defective bainitic structure, wherein at least the surface of the wear and/or corrosion protection layer can subsequently be modified by a second mechanical machining process.

### CROSS REFERENCE TO RELATED APPLICATIONS

This application is the U.S. national stage of International Application No. PCT/EP2023/085971, filed on 2023 Dec. 14. The international application claims the priority of DE 102022134171.2 filed on 2022 Dec. 20; all applications are incorporated by reference herein in their entirety.

### BACKGROUND

The present invention relates to the field of automotive engineering and industrial plant engineering and relates to a method for producing a braking element which may for example be in the form of a brake disk or brake drum, and to a braking element manufactured according to this method. The braking element produced according to the invention can be used, for example, in motor vehicles, or as a braking system for industrial brakes, or in wind turbines.

In addition to the main body, braking elements can be designed with special cooling structures to dissipate the frictional heat generated during the braking process.

Conventional brake disks are designed in a solid construction as non-ventilated or internally ventilated brake disks and can be made of a metallic or ceramic material.

Conventional brake drums are of solid construction, sometimes also provided with cooling structures on the outside of the drum, and can be made of a metallic or ceramic material.

To reduce particulate matter emissions, braking elements can also be provided with a housing.

Braking elements have multiple functional regions. For example, braking elements in motor vehicles are arranged on the front and rear axles and have for this purpose a contact surface that is in contact with the rim on the one hand and the wheel hub on the other. The entire braking element is connected via the contact surface using wheel bolts.

In addition, braking elements have regions with friction surfaces via which the braking effect is realized in interaction with rubbing brake pads.

Until now, braking elements have either been provided with short-term corrosion protection in the region of the friction surfaces or with long-term corrosion protection in the region of the cooling structures. The short-term corrosion protection protects the brake disk against corrosion only for a short period of time and is worn away during the first braking processes after delivery of a vehicle, for example. In addition, the friction surfaces have a wear-reducing coating which, in conjunction with the brake pads, achieves the braking effect.

Various methods are known from the prior art for producing brake disks and protecting them against corrosion and wear.

DE 10 2009 003 161 A1 discloses a coated light metal disk, and in particular a brake disk which is formed with a supporting disk, in particular made of a thermally resistant light metal alloy, and a heat-insulating friction layer that is made of a metal alloy containing nanocrystals. The light metal main body is coated by thermal spraying of a mechanically resistant metal alloy with the formation of nanoparticles in the sprayed layer.

From DE 102 03 507 A1, a brake disk for a vehicle is known comprising a main body made of a metallic material, in particular gray cast iron, which has at least one friction surface with a coating made of a hard material, the main body having a material thickness removed under the coating in the direction parallel to the axis of the brake disk, wherein the main body has a material thickness in the direction parallel to the axis of the brake disk which is removed approximately by the thickness of the coating, or up to +/−20% more or less, preferably +/−10%, relative to the thickness of the coating.

From DE 100 56 161 A1, a brake disk and method for its production are known in which a brake disk body made of a cast iron material is provided with a metallic, non-ceramic coating at least in portions and at least on one of its axial outer surfaces.

To prepare the contact surface to be coated of the main body, the existing oxide layer or also other impurities are removed from the contact surface, and the contact surface is roughened by irradiation with fine particles in order to increase the adhesion of the wear layer. The wear layer is then sprayed onto the contact surface of the main body using flame, arc or plasma injection molding coating methods.

Also known from WO 2012 156 114 A1 is a brake disk and a method for producing a brake disk, in which a brake disk has a main body with at least one contact surface to which a wear layer is applied, wherein in order to realize the bond between the wear layer and the main body, the at least one contact surface of the main body is pretreated. The at least one pretreated contact surface of the main body has a surface topography modified by laser radiation with at least one predetermined parameter in order to improve the positive-fit adhesion between the wear layer and the main body.

The known production methods have the significant disadvantage that a large material allowance must be taken into account already during the casting of the brake disk in order to ensure—after the first mechanical machining of the friction surfaces, which is known to be carried out by turning—a minimum design thickness of the disk-shaped friction surfaces to be coated, consisting exclusively of the basic structure on the friction strip surface. This machining allowance, which is present as chip volume after turning and can be described as the infeed of the machining tools, can be up to several millimeters, depending on the shape and position tolerances achieved during the casting process. To this extent, the known production methods are cost-intensive and complex since a high proportion of material waste is generated by the mechanical machining of the main body in preparation for coating with a wear and/or corrosion protection layer.

Another disadvantage is that known braking elements have a high weight which, for example, results in increased environmental pollution due to increased consumption values of the vehicle.

### SUMMARY

The invention relates to a method for producing a braking element and to a braking element. The object of the present invention is to provide a production method for a braking element which is cost-effective, saves material, and is simple. In addition, the object of the invention is to present a braking element that is weight-optimized and has improved wear and corrosion protection. The object is achieved by a method for producing a braking element which consists of a metal main body made of a cast material, having at least one disk-shaped or annular friction surface, wherein the cast metal main body has a base structure, a defective bainitic structure, and a cast skin layer which forms the cast surface, wherein for the metal part, the cast skin layer is at least partly removed at least in the region of the provided friction surface using a first machining process, a wear and/or corrosion protection layer is then arranged at least on the defective bainitic structure, wherein at least the surface of the wear and/or corrosion protection layer can subsequently be modified by a second mechanical machining process.

### DETAILED DESCRIPTION

The object of the present invention is to provide a production method for a braking element which is cost-effective, saves material, and is simple. In addition, the object of the invention is to present a braking element that is weight-optimized and has improved wear and corrosion protection.

The object is achieved by the invention indicated in the patent claims. Advantageous embodiments are the subject matter of the dependent claims, wherein the invention also includes combinations of the individual dependent claims in the sense of an “and” link, as long as they are not mutually exclusive.

The object is achieved by a method for producing a braking element which consists of a metal main body made of a cast material, having at least one disk-shaped or annular friction surface, wherein the cast metal main body has a base structure, a defective bainitic structure, and a cast skin layer which forms the cast surface, wherein for the metal part, the cast skin layer is at least partly removed at least in the region of the provided friction surface using a first machining process, a wear and/or corrosion protection layer is then arranged at least on the defective bainitic structure, wherein at least the surface of the wear and/or corrosion protection layer can subsequently be modified by a second mechanical machining process.

It is advantageous if at least parts of the casting skin layer are removed by grinding, laser radiation, abrasive methods, and/or chemical methods.

In an advantageous embodiment of the method, the casting skin layer is completely removed.

It is also advantageous if the first machining produces a graded thickness of the friction surfaces.

It is also advantageous if at least the surface of the defective bainitic structure is machined by laser radiation before coating.

It is also advantageous if the wear and/or corrosion protection layer is arranged in a single layer or in multiple layers.

In an advantageous embodiment of the method, a graded layer thickness and/or material composition of the wear and/or corrosion protection layer is arranged.

It can also advantageously be provided that the wear and/or corrosion protection layer is produced by direct metal deposition (DMD), direct energy deposition (DED), thermal spraying, plasma nitriding, plasma nitrocarburizing, thermochemical methods, and/or with the possible use of technical gases.

It is furthermore advantageous if the coating of the wear and/or corrosion protection layer is carried out with at least one hard metal, metal alloy, metal matrix with embedded carbides and/or oxide ceramics or a combination material of carbides and/or oxide ceramics.

It is also advantageous if a metallic buffer layer is arranged before coating the wear and/or corrosion protection layer.

It is also advantageous if at least the load-bearing cooling structures of the braking element are coated with an Al-based corrosion protection layer and are subsequently heat-treated.

The braking element produced according to the method according to the invention has at least one metallic main body made of a cast material with at least one disk-like or annular friction surface, wherein the cast metallic main body has at least one basic structure, a defective bainitic structure, and a cast skin layer, wherein a wear and/or corrosion protection layer is arranged at least on the surface of the defective bainitic structure, and wherein at least the friction surface has a joining zone which is formed at least from the wear and/or corrosion protection layer and the defective bainitic structure.

In an advantageous embodiment of the braking element, the wear and/or corrosion protection layer is arranged on the defective bainitic structure and the cast skin layer, wherein the surface portion of the cast skin layer present on the friction surface is up to 90%.

Also advantageously, the wear and/or corrosion protection layer is arranged in a materially bonded manner by a thermal coating method.

Advantageously, the layer thickness of the wear and/or corrosion protection layer and at least the defective bainitic structure is graded.

In addition, it can advantageously be provided that the wear and/or corrosion protection layer is formed in one layer or in multiple layers.

In an advantageous embodiment of the braking element, the layer thickness of the wear and/or corrosion protection layer is 50 μm to 200 μm for a single-layer coating or 125 μm to 250 μm for a two-layer coating.

Also advantageously, at least the cooling structures are coated with an Al-based corrosion protection layer.

Furthermore, it can advantageously be provided that there is a graded thickness of the friction surfaces and/or a graded material composition of the wear and/or corrosion protection layer.

The solution according to the invention provides a method for producing a braking element which is cost-effective, saves material, and is simple. In addition, a braking element is provided that is weight-optimized and has improved wear and corrosion protection.

Due to the casting process and the cooling behavior of the cast blank of a braking element, a metallic main body is provided which, in the case of metallic cast blanks made of steel or gray cast iron, substantially has three different regions.

The first region is the casting skin edge zone. According to the invention, a casting skin edge zone is understood to be a limited region on the surface of the casting which, depending on the material, can have different defects and deviations from the basic structure inside the casting. In this casting skin edge zone of the casting, there is a casting skin layer that forms during solidification of the melt through direct contact with the casting mold and the associated increased cooling rate, and is present as a fine crystalline structure.

Below the casting skin layer, but within the casting skin edge zone, there is a casting structure which, according to the invention, is to be understood as a defective bainitic structure. In this bainitic structure, there are undesirable defects within the structure. These can be non-metallic inclusions, gases or transformations in microscopic or macroscopic dimensions. Graphite inclusions in degenerate forms in gray cast iron materials should also be understood as non-metallic inclusions. The ordered forms of graphite should include, for example, lamellar graphite or spheroidal graphite, which according to the invention are explicitly not to be understood as degenerate forms of graphite.

Inside the metallic main body, a basic structure is formed that has the properties of the desired base material. The essential characteristics of the basic structure are that, in contrast to the bainitic structure, there are substantially no defects, and the structure is substantially homogeneous.

In an advantageous embodiment of the braking element, the basic structure can have an ordered graphite arrangement in the form of lamellar graphite or spheroidal graphite which enables a particularly cost-effective use of materials and economical machining of the metallic main body.

It is known from the prior art that after the casting process, the existing casting skin layer is present on the metallic main body with a layer thickness of 0.05 mm to 0.2 mm, in particular in the region of the disk-like friction surface in the case of brake disks, or the annular friction surface in the case of brake drums. In addition, it is known that the casting skin layer and the defective bainitic structure must be completely removed from the cast blank in order to prepare the region of the basic structure for subsequent coating with a wear and/or corrosion protection layer, or to supply it to the market as a conventional uncoated brake disk.

The method according to the invention provides a metallic main body made of a cast material in which a smaller amount of steel or iron cast material is used since, according to the invention, after the casting of the metallic main body, the casting skin edge zone is machined in a first machining step, and only the casting skin layer is at least partially removed in order to arrange a wear and/or corrosion protection layer at least on the defective bainitic structure.

In the context of the invention, an at least partial removal of the casting skin layer is to be understood as meaning that, in any case, regions of the defective bainitic structure are freed from the casting skin layer, wherein after the mechanical machining of the friction surfaces, the surface portion of the casting skin layer can be up to 90%.

The first machining operation can advantageously be carried out by grinding, laser radiation, abrasive processes and/or chemical processes. In particular, grinding the metallic main body enables, in contrast to the known removal of the casting skin layer by turning with a cutting tool, a homogeneous surface with higher dimensional accuracy and improved axial runout of the braking element so that the desired target geometry of the surface to be coated is achieved with the first machining. The precise grinding of the friction strip surfaces of the main body also results in an increased uniform layer thickness of the wear and/or corrosion protection layer as well as a reduction in the chip volume during finishing.

A further advantage is that grinding partly down to the defective bainitic structure results in significantly lower tool wear since, in contrast to the known multi-stage turning of the surface, unwanted vibrations and impact of the tool during machining in the region of the defective bainitic structure are avoided. The advantageous effects of grinding are further complemented by the fact that the material machining is only carried out up to the defective bainitic structure, which means that the tool is subjected to less stress than when turning due to the irregular material properties and the defects in the structure. Furthermore, the high precision of mechanical machining by grinding reduces the infeed dimensions of the finishing process, since shape deviations that occur have to be fed in to a lesser extent. Accordingly, the cycle time is reduced, the chip volume is lessened, and the process capacity of the mechanical finishing is increased.

In a particularly advantageous embodiment of the method, the cast main body can be manufactured with such a high production accuracy that the first step of mechanical machining of the friction surfaces and/or contact surfaces can be greatly simplified or even eliminated entirely.

After the first machining step, at least the surface of the friction surface, which substantially exists as a defective bainitic structure, is coated with a wear and/or corrosion protection layer using a coating method. By coating the surface of the defective bainitic structure with the wear and/or corrosion protection layer, at least the region of the friction surface has a joining zone which is formed at least from the wear and/or corrosion protection layer and the defective bainitic structure.

According to the prior art, cooling structures are dimensioned with an oxidation addition in the form of a material allowance since oxidation reactions reduce the strength of the material during daily use of the braking element. This applies both to the ventilation connecting elements between the friction surfaces of an internally ventilated brake disk and to the cooling structures of a brake drum.

In an advantageous embodiment of the method and the braking element, it can be provided that at least the cooling structures are coated with a permanently acting and materially bonded corrosion protection layer. At least the cooling structures can be coated particularly advantageously with an Al-based corrosion protection layer, and the corrosion protection layer can be arranged using a final heat treatment at least in the material of the ventilation connecting elements by diffusion processes.

By coating the cooling structures and subsequent heat treatment, it is possible to provide long-lasting protection against corrosion for the material structures forming the cooling structures, which eliminates oxidation additions in the design of the cooling structures and thus saving raw material.

A particularly good material bond between the material of the metallic main body and the material of the wear and/or corrosion protection layer can be achieved if the wear and/or corrosion protection layer is produced by a thermal coating process, particularly advantageously by direct metal deposition (DMD), direct energy deposition (DED), thermal spraying, plasma nitriding, plasma nitrocarburizing, and/or a thermochemical process, and with the possible use of technical gases.

Due to the existing differences with regard to heat generation in different zones of the friction surface and with regard to heat dissipation through different zones of the cooling structures and contact surfaces, different thermocyclic loads and deformations result in the region of the friction surfaces. In the case of a disk-shaped geometry of the friction surface in brake disks, this is additionally driven by the resulting different relative speeds between the pad and the friction strip with different distances from the axis of rotation.

In a particularly advantageous embodiment of the method, in order to improve the thermal balance in the braking element, it can be provided that the first mechanical machining of the friction surface produces a graded geometry by which a graded layer thickness is later realized during the coating. This ensures that improved heat conduction and thus a more even heat distribution within the braking element is made possible to compensate for different heat developments in the particular circumference of the friction surface. As a result, a homogenization of the heat flow within the metallic main body over the entire friction surface is achieved.

In order to achieve an optimized heat balance within the friction surface, a graded layer thickness and/or material composition of the friction surface can also be provided.

In order to achieve a standardized and improved surface quality, it can advantageously be provided that after the first machining and before the coating of the wear and/or corrosion protection layer, at least the surface of the defective bainitic structure is at least partially improved by laser irradiation.

The laser irradiation of the friction surface has the significant advantage that defects and contamination on the surface, for example due to existing graphite nests or grinding residues, are reduced. Furthermore, the reduction of near-surface carbon increases the available iron content in the bonding zone of the coating and reduces the uneven added alloying of carbon. The improvement of the surface makes it possible to achieve a high layer and bonding quality with a one-layer coating using a coating process, with regard to the increased content of metal capable of being materially bonded on the prepared friction strip surface.

With a thermal coating directly on the surface of the defective bainitic structure, a particularly thin wear and/or corrosion protection layer can be provided which in particular leads to a significant reduction in the material of the brake disk already during the casting process of the metallic main body. Thus, the wear and/or corrosion protection layer of the friction surface can advantageously have a layer thickness of 50 μm to 200 μm for a single-layer coating, and 125 μm to 250 μm for a two-layer coating.

The surface of the friction surface with the wear and/or corrosion protection layer can be coated with at least one hard metal, a metal alloy, a metal matrix with embedded carbides and/or oxide ceramics, or a combination material of carbide and oxide ceramics. In particular in the case of carbide materials, materials adapted to the load spectrum which act within the wear and/or corrosion protection coating can be used. It is conceivable, for example, to use mixed carbides and cermets, which for example have advantages in terms of their thermal expansion in the metal matrix composite and the associated reduction of crack structures and inherent stresses, their good thermal oxidation resistance, advantageous wettability compared to the matrix material, and their improved processing with the thermal coating methods.

In order to improve the material bonding of the wear and/or corrosion protection layer, it can be provided that a metallic buffer layer is arranged before coating the wear and/or corrosion protection layer.

The technical advantages of the production method according to the invention and the braking element produced thereby are, in summary, that
the simple machining and removal of the cast skin layer enables a direct coating on the friction strip surface of the defective bainitic structure and/or the partial cast skin layer, which realizes a reduction in the chip volume,
a reduction in material usage is made possible,
the thermal resistance between the metallic main body and the wear and/or corrosion protection layer is adapted to the thermocyclic load spectrum,
the required material allowance for oxidation and/or wear can be reduced or completely eliminated,
the performance of the braking element is increased and its comfort characteristics are improved,
a smaller allowance can be taken into account during the casting production of the metallic main body, thus saving costs through lower material usage,
the thermal coating method enables an improved material bonding of the wear and/or corrosion protection layer, and
the second mechanical machining for surface modification improves the friction strip surface and can be realized more efficiently.

### DETAILED DESCRIPTION OF THE PREFERRED EMBODIMENTS

The invention is explained in more detail below on the basis of an exemplary embodiment.

### Exemplary Embodiment

An internally ventilated brake disk produced by casting for a mid-size passenger car is provided with a hardness of 190-230 HV [3] in the region of the lamellar basic structure. The brake disk consists of a metallic main body made of gray cast iron and has two opposing friction surfaces as well as a contact surface for attaching the brake disk to a rotating axle. The two friction surfaces are connected by ventilation connecting elements.

After the metal main body has been removed from the casting mold, it is clamped centrally via the formed ventilation channels using workpiece clamping devices, and the provided contact surface is mechanically machined.

Subsequently, the existing casting skin layer is substantially completely removed by grinding on both sides of the friction strip down to the defective bainitic structure, which is a casting structure with a disordered graphite arrangement. The surface partially freed from the casting skin layer, which shows a casting structure with a disordered graphite arrangement and regions with a remaining casting skin layer, is irradiated by a CO₂ laser for surface normalization, and the surface is almost completely cleaned of grinding process and graphite residues. The brake disk is then fed into a thermal coating system, preheated inductively in a controlled manner to 185+/−5° C., measured on the surface to be coated, and a first corrosion protection layer made of a 316L stainless steel alloy is coated on the surface region intended as the friction surface by laser deposition welding in a locally generated argon protective gas atmosphere, and a material bond is produced between the surface region of the cast structure with a disordered graphite arrangement, individual surface regions with a cast skin layer, and the stainless steel alloy.

In a second coating process, a second layer consisting of a stainless steel alloy 430L with TiC hard material particles embedded in the metal matrix is arranged on the first layer by laser deposition welding.

To produce an improved surface topography, the produced wear and corrosion protection layer is then machined and modified in a second mechanical machining step by grinding. No mechanical machining of the surfaces takes place in the region of the ventilation ducts. The structures of the ventilation ducts are coated with an AlSi₁₂ alloy using LBD spraying and are then heat-treated.

The friction surfaces have a composite hardness of 500-750 HV [10] and long-term wear and corrosion protection.

With the production method according to the invention, the cast material to be used is reduced by 2.9 kg, and the weight of the brake disk is reduced by 1.1 kg in relation to a brake disk with a total friction strip area of approx. 1000 cm², compared to known conventional internally ventilated brake disks.

1. A method for producing a braking element which consists of a metal main body made of a cast material, having at least one disk-shaped or annular friction surface, wherein the cast metal main body has a microstructure, a defective bainitic structure, and a cast surface layer which forms the cast surface; for the metal part, the cast surface layer is at least partly removed at least in the region of the provided friction surface using a first machining process, a wear and/or corrosion protection layer is then arranged at least on the defective bainitic structure, and at least the surface of the wear and/or corrosion protection layer can subsequently be modified by a second mechanical machining process.

2. The method according to claim 1, in which at least parts of the casting skin layer are removed by grinding, laser radiation, abrasive methods, and/or chemical methods.

3. The method according to claim 1, in which the casting skin layer is completely removed.

4. The method according to claim 1, in which the first machining produces a graded thickness of the friction surfaces.

5. The method according to claim 1, in which at least the surface of the defective bainitic structure is machined by laser radiation before coating.

6. The method according to claim 1, in which the wear and/or corrosion protection layer is arranged in a single layer or in multiple layers.

7. The method according to claim 1, in which a graded layer thickness and/or material composition of the wear and/or corrosion protection layer is arranged.

8. The method according to claim 1, in which the wear and/or corrosion protection layer is produced by direct metal deposition (DMD), direct energy deposition (DED), thermal spraying, plasma nitriding, plasma nitrocarburizing, thermochemical methods, and/or with the possible use of technical gases.

9. The method according to claim 1, in which the wear and/or corrosion protection layer is coated with at least one hard metal, metal alloy, metal matrix with embedded carbides and/or oxide ceramics, or a combination material of carbides and/or oxide ceramics.

10. The method according to claim 1, in which a metallic buffer layer is arranged before the coating of the wear and/or corrosion protection layer.

11. The method according to claim 1, in which at least the load-bearing cooling structures of the braking element are coated with an Al-based corrosion protection layer and are subsequently heat-treated.

12. A braking element, produced according to claim 1, which has at least one metallic main body made of a cast material with at least one disk-like or annular friction surface, wherein the cast metallic main body has at least one basic structure, a defective bainitic structure, and a cast skin layer, wherein a wear and/or corrosion protection layer is arranged at least on the surface of the defective bainitic structure, and wherein at least the friction surface has a joining zone which is formed at least from the wear and/or corrosion protection layer and the defective bainitic structure.

13. The braking element according to claim 12, in which the wear and/or corrosion protection layer is arranged on the defective bainitic structure and the cast skin layer, wherein the surface portion of the cast skin layer present on the friction surface is up to 90%.

14. The braking element according to claim 12, in which the wear and/or corrosion protection layer is arranged in a materially bonded manner by a thermal coating method.

15. The braking element according to claim 12, in which the layer thickness of the wear and/or corrosion protection layer and at least the defective bainitic structure is graded.

16. The braking element according to claim 12, in which the wear and/or corrosion protection layer is formed in one layer or in multiple layers.

17. The braking element according to claim 12, in which the layer thickness of the wear and/or corrosion protection layer is 50 μm to 200 μm for a single-layer coating or 125 μm to 250 μm for a two-layer coating.

18. The braking element according to claim 12, in which at least the cooling structures are coated with an Al-based corrosion protection layer.

19. The braking element according to claim 12, in which there is a graded thickness of the friction surfaces and/or a graded material composition of the wear and/or corrosion protection layer.
